(19) United States
(12) Patent Application Publication
(10) Pub. No.: US 2026/0323738 A1
(43) Pub. Date: Oct. 15, 2026

(54) METHODS AND COMMUNICATIONS DEVICES

(71) Applicant: Sony Group Corporation, Tokyo (JP)

(72) Inventors: Vivek SHARMA, Basingstoke (GB); Yuxin WEI, Basingstoke (GB); Yassin Aden AWAD, Basingstoke (GB); Hideji WAKABAYASHI, Basingstoke (GB)

(73) Assignee: Sony Group Corporation, Tokyo (JP)

(21) Appl. No.: 18/880,844

(22) PCT Filed: Jul. 6, 2023
(86) PCT No.: PCT/EP2023/068702

§ 371 Date: Jan. 3, 2025

(30) Foreign Application Priority Data
Jul. 13, 2022 (EP) 22184827.8

(51) Int. Cl. H04W 76/15; H04W 8/30; H04W 76/14; H04W 76/30; H04W 92/18

(52) U.S. Cl. CPC H04W 76/15; H04W 8/30; H04W 76/14; H04W 76/30; H04W 92/18

(57) ABSTRACT

The method comprises either determining that a link quality of the indirect communications link can no longer support the communication of the data units, and transmitting an indication via the direct communications link that the indirect communications link can no longer support the communication of the data units and a status report of the transmission or the reception of the data units for recovering any of the data units which have been lost, or determining that a link quality of the direct communications link can no longer support the communication of the data units and transmitting an indication via the indirect communications link that the direct communications link can no longer support the communication of the data units and a status report of the transmission or the reception of the data units for recovering any of the data units which have been lost.

### BACKGROUND

### Field of Disclosure

The present disclosure relates to methods and communications devices (user equipment or wireless transceiver units), which are configured to transmit or to receive using multipath communication comprising a direct communications link with an infrastructure equipment and an indirect communications link with a relay device via a sidelink communications link. The present disclosure claims the Paris convention priority of European patent application EP 22184827.8 filed on 13 Jul. 2022, the contents of which are incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Wireless communications networks are now supporting communications to a wider range of communications devices and user equipment for a variety of applications and data traffic profiles and types. For example, communications are now supported with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance.

In order to provide coverage for an increasing range of devices, such as IoT, 5G radio access technologies (RAT), also referred to as new radio (NR) systems, include aspects and features which are devised to support connectivity over a wide range of environments. For example, in order to improve coverage for communications devices (user equipment etc.), techniques may be employed to utilise ad hoc relay devices formed by other communications devices. A wireless access interface to the relay device is referred to as a sidelink. For the example of 3GPP, the sidelink interface is referred to as a PC5 interface, whereas a direct communications interface with an infrastructure equipment of the wireless communication networks is referred to as a Uu interface. Utilising both a direct communications link and an indirect communications link can present technical challenges.

### SUMMARY OF THE DISCLOSURE

The present disclosure can help address or mitigate at least some of the issues discussed above.

Embodiments of the present technique can provide a method performed by a communications device to transmit data to or to receive data from a wireless communications network, the method comprising establishing a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment, and transmitting data units to the radio network infrastructure equipment using the multipath communication, or receiving data units from the radio network infrastructure equipment using the multipath communication. The direct communications link with the infrastructure equipment may be a Uu interface, whereas the sidelink communications link with the relay may use a PC5 interface. The method comprises either determining that a link quality of the indirect communications link can no longer support the communication of the data units, and transmitting an indication via the direct communications link that the indirect communications link can no longer support the communication of the data units and a status report of the transmission or the reception of the data units for recovering any of the data units which have been lost, or determining that a link quality of the direct communications link can no longer support the communication of the data units and transmitting an indication via the indirect communications link that the direct communications link can no longer support the communication of the data units and a status report of the transmission or the reception of the data units for recovering any of the data units which have been lost.

Example embodiments can provide an efficient recovery of a multipath communication between the communications device and an infrastructure equipment by detecting when one of a direct communications link via a Uu interface to the infrastructure equipment (gNB) or an indirect communications link using a relay via a sidelink or PC5 interface is no longer supporting the communication of the data units and transmitting an indication via the other of the direct or indirect communications links, which has not failed, and transmitting an indication of data units which have either successfully been communicated or a last of the data units to be communicated so that the network can identify those data units which have been lost as a result of a failure in the direct or indirect communications links. In one example the data units are packet data convergence protocol (PDCP) packet data units (PDU).

Other aspects of the example embodiments also relate to techniques for recovering data units when one or more of an indirect and direct communications link of a multipath communication fail, in which a cell ID of the cell formed by the infrastructure equipment providing the direct communications link and an ID of the relay is communicated as part of a re-establishment procedure.

Respective aspects and features of the present disclosure are defined in the appended claims and include a communications device (UE), and infrastructure equipment and methods for operating the same.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a 5G/new radio access technology (RAT) wireless communications system which may be configured to operate in accordance with embodiments of the present disclosure;

FIG. 2 is a schematic block diagram of an example scenario in which a remote communications device is configured to transmit or to receive data as PDC P packet data units using a direct communications path link with an infrastructure equipment of the wireless litigations network and an indirect communications path via a relay communications device according to example embodiments of the present disclosure;

FIG. 3A is an example illustrating an arrangement shown in FIG. 2 in which one of a communications link between the relay communications device and an infrastructure equipment forming part of an indirect communications link has failed or is considered to not support communication of PDUs;

FIG. 3B is an example illustrating the arrangement shown in FIG. 2 in which an indirect communications link between a remote communications device and the relay communications device via a sidelink has failed or is considered to not support communication of PDUs; and FIG. 3C is an example illustrating the arrangement of FIG. 2 in which the direct communications link between the remote communications device and the infrastructure equipment has failed or is considered to not support communication of PDUs.

FIG. 4 is a schematic block diagram showing the example arrangement of FIG. 2 showing a more detailed implementation of a remote communications device, a relay communications device and a radio network infrastructure equipment;

FIG. 5 is a message flow diagram illustrating an example embodiment in which a direct communications path between a remote communications device and an infrastructure equipment has failed or is considered not to support a communication of PDUs;

FIG. 6 is a message flow diagram illustrating an example embodiment of the present technique in which an indirect communications path between a remote UE and an infrastructure equipment via a relay communications device is no longer able to support communication of PDUs via a sidelink; and

FIG. 7 is a message flow diagram illustrating an example embodiment in which both a direct communications link and an indirect communications link between a remote UE and an infrastructure equipment has failed or is considered not to support communication of PDUs.

### DETAILED DESCRIPTION OF THE EMBODIMENTS

### New Radio Access Technology (5G)

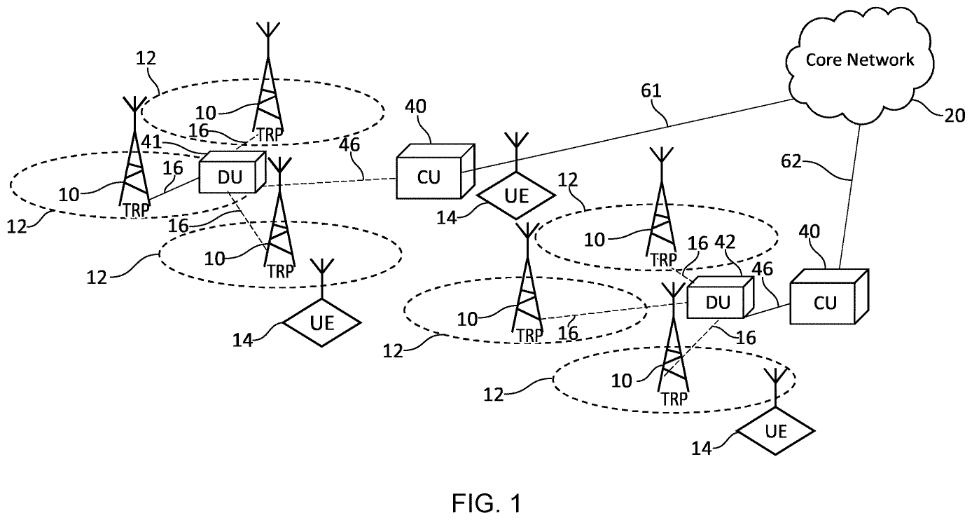

An example configuration of a wireless communications network which uses some of the terminology proposed for and used in NR and 5G is shown in FIG. 1. In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

As will be appreciated by those acquainted with the wireless communications network according to a 5G standard as shown in FIG. 1, the CU 40, DU 42 and TRPs 10 collectively refer to functions which are conventionally performed by a network base station or, in accordance with 5G terminology, a gNodeB (gNB). In terms of broad top-level functionality, the term network infrastructure equipment/access node may be used to encompass these elements and more conventional base station type elements of wireless telecommunications systems. Depending on the application at hand, the responsibility for scheduling transmissions which are scheduled on the radio interface between the respective DUs and the communications devices may lie with the controlling node/central unit and/or the distributed units/TRPs.

A communications device 14 is represented in FIG. 1 within the coverage area of the first communication cell 12. This communications device 14 may thus exchange signalling with the first CU 40 in the first communication cell 12 via one of the distributed units/TRPs 10 associated with the first communication cell 12. The communications devices 14 may be referred to as mobile terminals, terminals or user equipment (UE), which encompasses chip sets and have a functionality corresponding to the UE devices known for operation with wireless communications networks.

As indicated above, example embodiments can provide an arrangement for improving reliability and communications quality for examples in which a remote UE is transmitting or receiving data directly with the wireless communications network, that is transmitting and/or receiving data to and from a wireless infrastructure equipment for example a gNodeB be what TRP of FIG. 1, and indirectly via a relay UE. The relay UE acts to receive data from and to transmit data to a remote UE and transmit that data on or receive data from a gNB in a wireless communications network. Example embodiments therefore relate to a multipath scenario in which a remote UE is using a communications path directly with the wireless communications network and indirectly with the wireless communications network via a relay UE.

It has already been considered that service continuity can be enhanced for single hop layer to UE to network relay, by switching between direct and indirect communications. For example, the following scenarios are envisaged:
A. Inter-gNB indirect-to-direct path switching, that is switching from UE 1<->relay UE A<->gNB X to UE 1<->gNB Y;
B. Inter-gNB direct-to-indirect path switching, that is switching from UE 1<->gNB X to UE 1<->relay UE A<->gNB Y;
C. Intra-gNB indirect-to-indirect path switching, that is switching from UE 1<->relay UE A<->gNB X to UE 1<->relay UE B<->gNB X;
D. Inter-gNB indirect-to-indirect path switching, that is switching from UE 1<->relay UE A<->gNB X to UE 1<->relay UE B<->gNB Y;

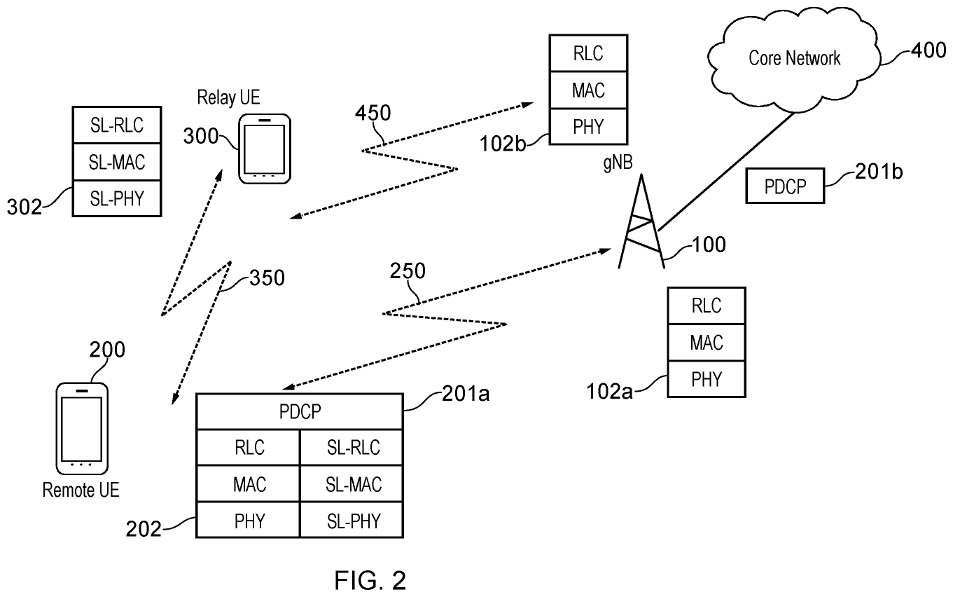

There is also considered that there should be multi-path communications in which a Layer-2 and Layer-3 communication is provided via both direct and indirect paths to enhance reliability and throughout in different scenarios. That is, in a multipath scenario, a remote UE is connected to gNB via direct and indirect links whereby an indirect link is via a relay UE to the wireless communications network. According to multi-path communications, a UE will have both Uu and PC5 link active at the same time and user traffic may be split/merged in the PDCP layer of gNB and UE (Uu PDCP). The benefit of this approach is that Uu PDCP security between gNB and UE can be used even if traffic is via UE to network relay. So, user data for downlink communication is encrypted in PDCP entity in gNB-CU and then traffic may be switched between Uu link and another link via Relay UE. Both Remote UE and Relay UE link are Uu links and will be sent over a radio link control, RLC, channel. That is to say that the data is split between direct and indirect communications. An example of a multi-path communication is shown in FIG. 2.

As shown in FIG. 2 a remote UE 200 is transmitting and receiving data via wireless communications network in which a gNB 100 forms part of a radio network infrastructure equipment of the wireless communications network and is connected to a core network 400. As shown in FIG. 2, the remote UE 200 is communicating data using a PDCP protocol layer 201a, 201b via a data link with the gNB 100. The PDCP layer 201a, 201b forms part of a protocol stack 202 represented as a table on the remote UE 200 and the gNB 100 as two protocol stacks 102a, 102b for a direct communications link 102a and an indirect communications link 102b. The remote UE 200 is able to communicate data at the PDCP layer 201a, 201b with the gNB 100 via the direct communications link 250 with the gNB 100, and an indirect communications link 350, 450 via a relay UE 300. The communications link 350 with the relay UE 300 is formed from a PC 5 interface. The protocol stack 202 is within the remote UE 200 therefore includes a radio link control layer SL-RLC, a media access layer SL-MAC and the physical layer SL-PHY for a sidelink, via which data from the PDCP is communicated via the sidelink 350 to the relay UE and from the relay UE 300 to the gNB 100 via a second direct communications link 450. As shown for a protocol stack 202 within the remote UE 200, the PDCP data is communicated via the direct communications link 250 formed from a Uu interface also using a radio link control layer RLC, a media access layer MAC and physical layer PHY and corresponding layers within a protocol stack 102a at the gNB 100. Thus according to the arrangement shown in FIG. 2, PDCP data is communicated as protocol data units (PDUs) that is transmitted or received to or from the gNB 100 using the protocol stack 202, 102a, 102b according to the techniques currently proposed. That is according to the arrangement shown in FIG. 2, the relay UE 300 maps remote UE traffic received from gNB to the sidelink 350. The remote UE 200 will have PDCP PDUs received from both the Uu and SL interfaces. A PDCP entity in the UE will combine the traffic at the PDCP layer 201a. In addition, there will be SL-SDAP and SL-PDCP entities between Relay UE and Remote UE, which are not shown here for simplification. Similarly, for the uplink direction, the remote UE PDCP entity will split the traffic and transmit this as PDCP PDUs via the direct 250 and indirect communications paths 350, 450, which are then received at the gNB via direct or via the relay UE 300. Splitting of traffic is one example and redundant traffic is another example. Traffic split on the downlink may be a network decision. For uplink traffic splitting, the network shall configure the rule for a UE to split the data, for example a splitting ratio 50:50 or 60:40 based on traffic volume and/or radio conditions. However, embodiments of the present technique serve to address a problem in which a multipath communication of the PDCP data, which is either repeated on the indirect communications path 350, 450 or switched between the indirect communications path 350, 450 and the direct communications path 250 suffers a radio link failure. This will be explained in the following paragraphs.

### Radio Link Failure

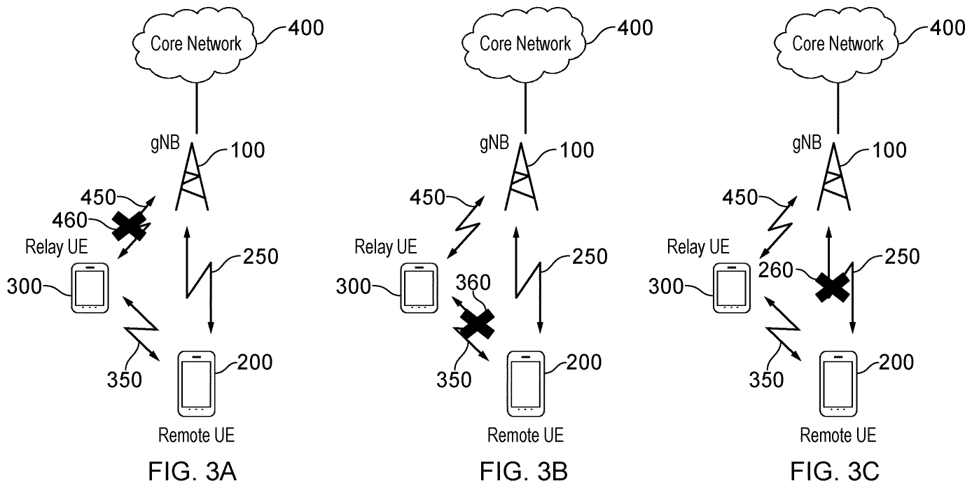

If a remote UE is providing a service which is supported by a multi-path communication links, then there is a technical problem in addressing a situation in which one or both a direct (Uu) and an indirect (PC5) communication link of a multipath communication fail. In a multipath communication scenario, if both links Uu and SL fail then the UE can declare radio link failure (RLF). If one of the links fails then it should be possible to report RLF from the other surviving link, which is, in principle, the same behaviour as RLF reporting when configured with dual connectivity. Some possible scenarios are represented in FIGS. 3A, 3B and 3C where parts shown in FIG. 2 that the same numerical designations. As shown in FIG. 3A, the remote UE 200 is being serviced by a multipath communication comprising a direct communications link 250, and an indirect communications path via a relay UE using communications links 350, 450 which corresponds to the arrangement shown in FIG. 2. As shown in FIG. 3A a black cross 460 indicates that the Uu communications link between the relay UE 300 and the gNB 100 has failed, whereas in FIG. 3B a black cross 360 illustrates that the sidelink communications link 350 between the remote UE 200 and the relay 300 has failed. Finally, in FIG. 3C the direct communications link 250 between the remote UE 200 and the gNB 100 has failed as illustrated by the black cross 260.

Radio Link Failure (RLF) in a scenario in which a UE can switch between a direct and an indirect communications path is considered in TS 38.300 which considers RLF on a sidelink and an operation during the failure of a direct communications path on the Uu interface. This disclosure together with that in TS 38.331 provides for a radio beam failure or physical layer failure on an indirect communications link via the PC 5 interface and the direct communications link via a Uu interface and an initiation of a radio resource control action re-establishment procedure. There is also considered operations during handover in which a UE can be provided with a configured sidelink granting handover. The scenarios in this disclosure specify handling based on assumption that a UE may perform side link communication in RRC connected mode and may use Uu link to report any failure on the sidelink. This procedure can be used when a Uu is configured with multipath communication. However, there remains a technical problem in respect of handling radio link failure (RLF) generally for multi-path communication, and more particularly handling RLF on a direct communications link with a radio network infrastructure equipment via a Uu interface by managing and reporting using an indirect communications path with the infrastructure equipment using a relay node via a PC5 interface. In other embodiments, a technical problem concerns a handling a sidelink (SL) RLF, that is, a failure on SL via a PC5 interface on an indirect communications path to a radio network infrastructure equipment via a relay device. In some example embodiments a UE may have more than one SL to more than one relay device for communicating on an indirect communications path to the radio network infrastructure equipment, and RLF may occur on one of those SL to one of those relay devices. In response the UE may transmit a message via a direct communications link of a multi-path communications link via a Uu interface identifying which SL communications link with which relay device has suffered RLF, which may also include an indication of which of the SL has survived, although this may be implicit as remaining links have survived.

In other example embodiments, a UE may establish a multi-path communications link, in which a direct communications path is established using a plurality of carriers, that is a Uu interface with carrier aggregation or dual connectivity, so that if communication on one carrier fails, communications can continue and the RLF can be reported on either a surviving carrier or via a surviving SL.

Embodiments of the present technique can provide a method performed by a communications device to transmit data to or to receive data from a wireless communications network, the method comprising establishing a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment, and transmitting data units to the radio network infrastructure equipment using the multipath communication, or receiving data units from the radio network infrastructure equipment using the multipath communication. The method comprises determining that a link quality of the direct communications link can no longer support the communication of the data units and transmitting an indication via the indirect communications link that the direct communications link can no longer support the communication of the data units and a status report of the transmission or the reception of the data units for recovering any of the data units which have been lost.

According to another example embodiment, after establishing a multi-path communications link a communications device is configured to operate by determining that a link quality of the indirect communications link can no longer support the communication of the data units by the transmitting of the data units to the radio network infrastructure equipment or by the receiving of the data units from the radio network infrastructure equipment via the sidelink communications link, and transmitting an indication via the direct communications link that the indirect communications link can no longer support the communication of the data units with an indication that the indirect communications path is released with a status report of the transmission or the reception of the data units for use in recovering any of the data units which have been lost. The indication may be transmitted for example a Uu message.

Embodiments provide techniques to address the following examples:
1. When RLF occurs on both direct and indirect communications links and a UE attempts to perform RRC re-establishment, the re-establishment may take a long time. For this reason, a UE may be able to discover a sidelink relay UE before a re-establishment procedure is successful. If a sidelink discovery is successful and a PC5 interface can be established then RLF can be reported via SL involving a new relay or old relay.
2. When RLF occurs on a SL/PC-5 interface, then the PC-5 RRC connection is released and reported to the gNB using SLinformation via a Uu message, with a procedure to manage data loss, including for example a new PDCP status report or last successful received PDCP serial number SN included in SL information Uu message.

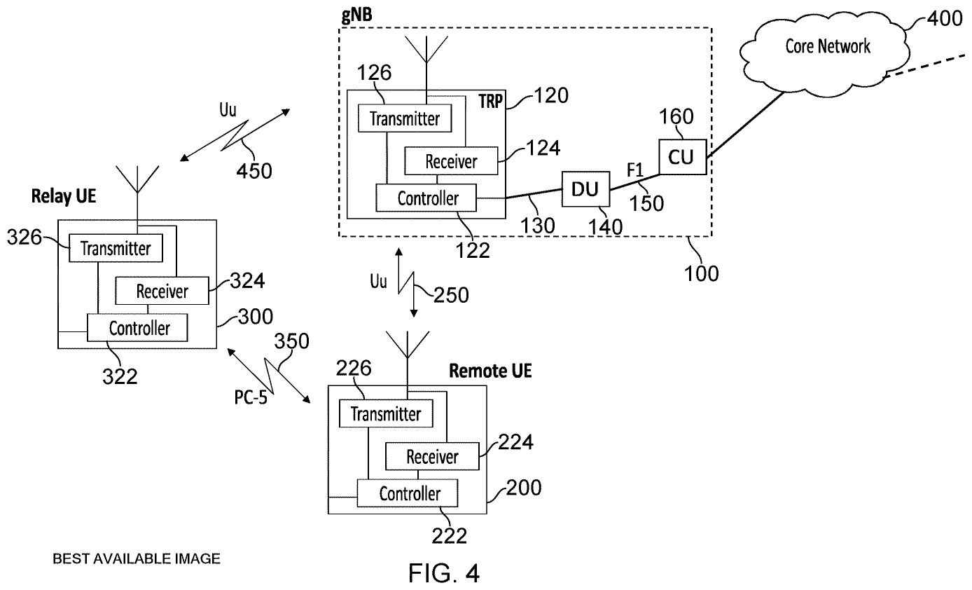

A more detailed diagram of components shown in FIGS. 1 and 2 is provided by FIG. 4. In FIG. 4, a TRP 120, which broadly corresponds to TRP 10 in FIG. 1, comprises, as a simplified representation, a transmitter 126, a receiver 124 and a controller or controlling processor 122 which may operate to control the transmitter 126 and the receiver 124 to transmit and receive radio signals to one or more UEs within a cell (not shown in FIG. 3 for clarity) provided by the TRP 120.

As shown in FIG. 4, the TRP 120 is connected to a DU 140 via a physical interface 130 which may be a fibre optic cable, for example. The physical interface 130 therefore provides a communications link for data and signalling traffic from the TRP 210 via the DU 140 and a CU 160 to a core network 400. An interface 150 between the DU 140 and the CU 160 is known as the F1 interface which can be a physical or a logical interface. The F1 interface 150 between the DU 140 and the CU 160 may operate in accordance with specifications 3GPP TS 38.470 and 3GPP TS 38.473, and may be formed from a fibre optic or other wired or wireless high bandwidth connection. The connection between a TRP 210 and the core network 400 can be generally referred to as a backhaul, which comprises the physical interface 130 from the TRP 120 to the DU 140 and the F1 interface 150 from the DU 140 to the CU 160.

As shown in FIG. 2, the TRP 120 may be configured to transmit downlink radio signals and receive uplink radio signals from a remote UE 200 over a direct wireless communications link 250 to the remote UE 200. The direct wireless communications link 250 may be a Uu interface in one example. The remote UE 200 is shown to include a transmitter 226, a receiver 224 and a controller 222 which is configured to control the transmitter 226 and the receiver 224 to transmit uplink signals to the TRP 120 and to receive downlink signals from the TRP 120 over the wireless communications link 250 formed between the remote UE 200 and the TRP 120. When the remote UE 200 communicates with the TRP 120/gNB 100 over the direct wireless communications link 250 between the remote UE 200 and the TRP 120/gNB 100, the remote UE 200 can be said to be communicating with the TRP 120/gNB 100 via a “direct path”. A direct wireless communications link for a communications device (such as a UE) is to be construed as a wireless communications link to infrastructure equipment of a wireless communications network (such as a gNB) without intermediary wireless communications links (such as sidelink wireless communications links).

As shown in FIG. 4, the TRP 120 may be configured to transmit downlink radio signals and receive uplink radio signals from a relay UE 200 over a direct wireless communications link 450. The direct wireless communications link 450 may be a Uu interface in one example. The relay UE 300 is shown to include a transmitter 326, a receiver 324 and a controller 322 which is configured to control the transmitter 326 and the receiver 324 to transmit uplink signals to the TRP 120 and to receive downlink signals from the TRP 120 over the direct wireless communications link 450 formed between the relay UE 300 and the TRP 120.

As shown in FIG. 4, the controller 322 of the relay UE 300 may be configured to control the transmitter 326 to transmit downlink signals to the remote UE 200 over a sidelink wireless communications link 350 and to control the receiver 324 to receive uplink signals from the remote UE 200 over the sidelink wireless communications link 350. Similarly, the controller of the remote UE 200 may be configured to control the receiver 224 to receive downlink signals from the relay UE 300 and to control the transmitter 226 to transmit uplink signals to the relay UE 300. The sidelink wireless communications link 350 between the relay UE 300 and the remote UE 200 is a sidelink wireless communications link such as a PC-5 interface. Therefore, the relay UE 300 may be configured to relay signals between the remote UE 200 and the TRP 120. When the remote UE 200 is communicating with the TRP 120/gNB 100 via the relay UE 300 (that is, via the sidelink wireless communications link 350 between the remote UE 200 and the relay UE 300 and the direct wireless communications link 450 between the relay UE 300 and the TRP 120/gNB 100), the remote UE 200 can be said to be communicating with the gNB 100 via an “indirect path”. Although not shown in FIG. 4, an indirect path may further comprise one or more further relay UEs.

In the example shown in FIG. 4, since the relay UE 300 relays signals between the remote UE 200 and infrastructure equipment of the wireless communications network (i.e. the gNB 100), the relay UE 300 may be referred to as a “UE-to-Network (U2N)” relay. As will be appreciated by one skilled in the art, one or more other relay UEs may relay signals between the remote UE 200 and the relay UE 300 along the indirect path to the gNB 100, thereby acting as “UE-to-UE (U2U)” relays.

The transmitters 126, 226, 326 and the receivers 124, 224, 324 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 122, 222, 322 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s).

As shown in FIG. 4, the TRP 120, DU 140 and the CU 160 may collectively form a gNB 100 which is an example of infrastructure equipment of a wireless communications network. Therefore, references to the remote UE 200 or relay UE 300 communicating with the TRP 120 can alternatively be considered as references to the remote UE 200 or relay UE 300 communicating with the gNB 100. Furthermore, it will be appreciated that the remote UE 200 and the relay UE 300 are examples of communications devices. As will be appreciated the infrastructure equipment/TRP/base station/gNB as well as the UE/communications device will in general comprise various other elements associated with its operating functionality.

Therefore, as explained above, the remote UE 200 may communicate with the gNB 100 either via a direct path (i.e. via the direct wireless communications 250 link between the remote UE 200 and the gNB 100) or via an indirect path (i.e. via the sidelink wireless communications link 350 between the remote UE 200 and the relay UE 300 and the direct wireless communications link 450 between the relay UE 300 and the gNB 100). Conventionally, the remote UE 200 is configured at any one time to communicate either via the direct path or the indirect path but not both simultaneously. For example, the remote UE 200 may be configured to communicate via the direct path when the remote UE 200 is in the cell provided by the gNB 100. Alternatively, the remote UE 200 may be configured to communicate via the indirect path when the remote UE 200 is outside the cell provided by the TRP 120 but the relay UE 300 is inside the cell provided by the TRP 120. The relay UE 300 can thus provide coverage for the remote UE 200.

### Uu Link Failure and Reporting to gNB via Relay UE

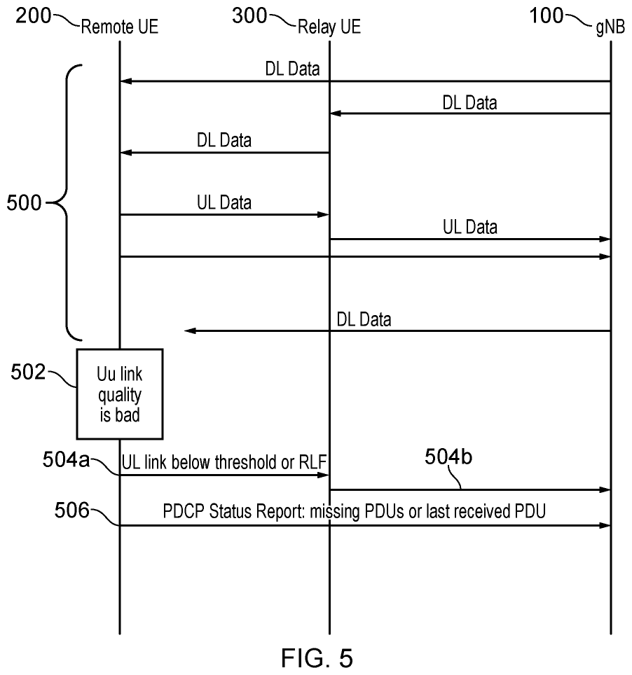

According to example embodiments, once a UE has detected that Uu link has either failed or Uu link quality is below a threshold then the UE informs the relay UE that the Uu link is no longer able to support communications via the direct communications link. This example is shown in FIG. 5. As shown during a first phase in FIG. 5, a remote UE 200 is supported by multipath communications using a direct communications link via a Uu interface with a gNB 100, and an indirect communications path via a remote UE 300 using a sidelink (SL) PC5 interface with the relay UE 300 and the relay UE having established a communications link with the gNB 100 via a Uu interface. As shown, during an initial phase 500, the remote UE receives downlink data in the form of PDUs from the gNB 100, and transmits uplink data as PDUs to the gNB 100 using a multipath communications via a direct link (via Uu interface) and via an indirect communications link via the relay UE 300 (using a PC5 interface). At some point 502 however, a link quality of the Uu interface with the gNB 100 falls below a predetermined threshold and so the Uu interface is no longer available on the direct communication link with the gNB 100.

A threshold may be configured by the network, which may reuse an existing event A2 in an established handover procedure, to determine that the communications link with the gNB 100 via the Uu interface is below a level which will support the communication of PDCP PDUs. The wireless communications network can configure multiple thresholds for event A2 ie one threshold when traffic is split and a lower threshold if the same traffic is sent over both the direct and indirect communications paths (Uu and SL) or based on network or UE implementation. According to example embodiments therefore once the remote UE 200 has determined that the direct communications link with the gNB 100 via the Uu interface has either failed or is below a predetermined threshold, the remote UE 200 sends an indication that the direct communications path is no longer able to support communication of PDUs to/from the gNB 100 via the indirect communications path, that is via the relay UE 504a, 504b. According to example embodiments the wireless communications network can then direct the remote UE 200 to establish and to communicate traffic (PDUs) via another communications link based on this indication. The other communications link may be established with another gNB as part of a handover or via another relay UE (sidelink) or maintain single link for some time. Furthermore, the remote UE 200 may report the status of successfully received or transmitted PDCP PDUs, in order to identify those PDUs who have not been transmitted or received successfully. It is better to report PDCP PDUs because PDCP in the gNB-CU can reconcile the data loss and we already have a framework of performing PDCP status reporting (done at RLF and Handover whereby UE reports missing PDCP SN and already known and implemented in 38.300/38.323 and configured by RRC 38.331). However, it can be done on RLC layer as well.

According to example embodiments therefore, once the remote UE 200 has detected that Uu link has either failed or Uu link quality is below a threshold then the remote UE 200 can inform the relay UE that the direct communications link via Uu interface is no longer available to it to support communication of data. An event that the Uu link quality is below a threshold could be an event A2. When Uu link has failed then an indication of this failure is sent to the gNB 100 via the slide link (PC5), that is the indirect communications link and the relay UE 300. According to example embodiments, the remote UE 200 then reports the status of either successfully received or transmitted PDCP PDUs, so that the corresponding entity within the gNB 100 can identify any PDU which were not successfully transmitted or received.

### SL Link Failure and Reporting to gNB

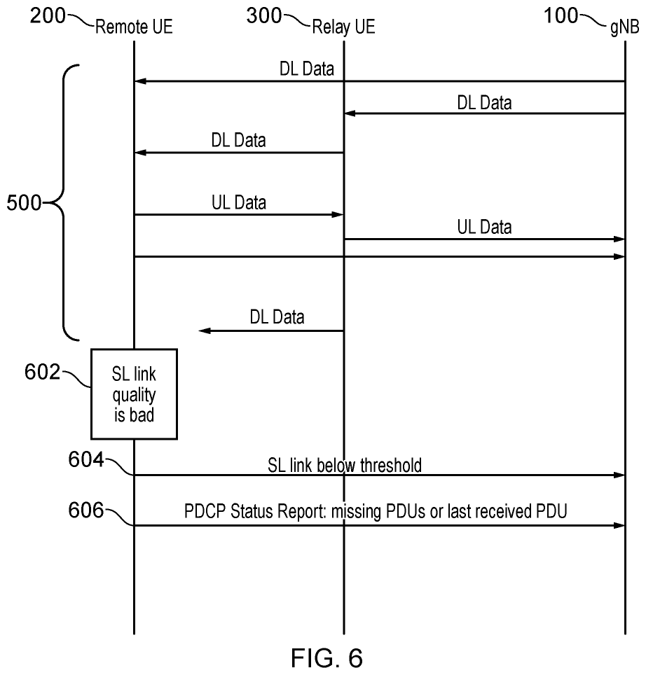

Another example embodiment is shown in FIG. 6, which corresponds to the example embodiments of FIG. 5, for an example in which an indirect communications link to the relay UE 300 fails or a link quality falls below a predetermined threshold established for an acceptably efficient communication integrity. For the example shown in FIG. 6, as for the example of FIG. 5, during the initial phase 500, the remote UE 200 receives downlink data in the form of PDUs from the gNB 100, and transmits uplink data as PDUs to the gNB 100 using a multipath communication via a direct link (via Uu interface) and via an indirect communications link via the relay UE 300 (using a PC5 interface). At point 602 however, a link quality of the PC5 interface with the Relay UE 300 falls below a predetermined threshold or is considered to have failed and so the communication path via the relay UE 300 is no longer available on the indirect communication link with the gNB 100. In this example, there already exists a procedure for the remote UE 200 to report a sidelink-radio link failure (SL-RLF) to the wireless communications network, via the direct communications link, that is via the Uu interface to the gNB 100. The reporting of the sidelink failure 604 is shown after detecting the sidelink failure or fall of the link quality below a predetermined threshold. Currently an existing event X2 (conventionally used for triggering handover), in which a serving L2 U2N Relay UE becomes worse than absolute threshold, can be used to send a message that a SL link quality has fallen below a predetermined threshold or has failed. Then the remote UE 200 reports a PDCP Status to the gNB 100 via the direct communications link Uu interface as represented by an arrow 606.

According to this example embodiment, an event X2 is reported by the remote UE, which triggers a PDCP status report procedure in a corresponding way to which the remote UE reported the PDCP status report when the direct communications link via the Uu interface has failed. According to some example embodiments an event X2, for use in triggering a failure or identification that the link quality is not good enough to support efficient communication may be determined by comparing the link quality with different thresholds where the multipath communication is used for either redundancy or splitting between the direct and indirect communications paths.

In some example embodiments a form and procedure of a PDCP status report, which is triggered after an event X2 may be configured by the wireless communications network.

According to another example embodiment represented by FIG. 6, a UE may have more than one SL to more than one relay UE 300 to communicate on an indirect communications path to the radio network infrastructure equipment. A RLF which occurs on one or more of those SL to one or more of those relay devices such as in the step 602, may cause the UE in response to transmit a Uu message via a direct communications link of a multi-path communications link via a Uu interface in step 604, which identifies the SL communications link with which the relay device has suffered RLF, and also includes an indication of which of the SL has survived, although this may be implicit. For example, if there are only two SLs to two relay devices and one has suffered RLF then it is implicit that the other has survived. In general, however, one can appreciate that there may be N indirect or SL with L relay devices and M of those SLs suffer from RLF, then N-M have survived. The N-M survived links may be implicit by indicating to the wireless communications network then M which have suffered from RLF or the N-M surviving links may be explicitly indicated in a Uu message.

According to another example embodiment, after establishing a multi-path communications link a UE is configured to operate by determining that a link quality of the indirect communications link can no longer support the communication of the data units by the transmitting of the data units to the radio network infrastructure equipment or by the receiving of the data units from the radio network infrastructure equipment via the sidelink communications link, and transmitting an indication via the direct communications link that the indirect communications link can no longer support the communication of the data units with an indication that the indirect communications path is released with a status report of the transmission or the reception of the data units for use in recovering any of the data units which have been lost. The indication may be transmitted for example as Uu message.

### Both Link Failure and Recovery Via Another Relay UE

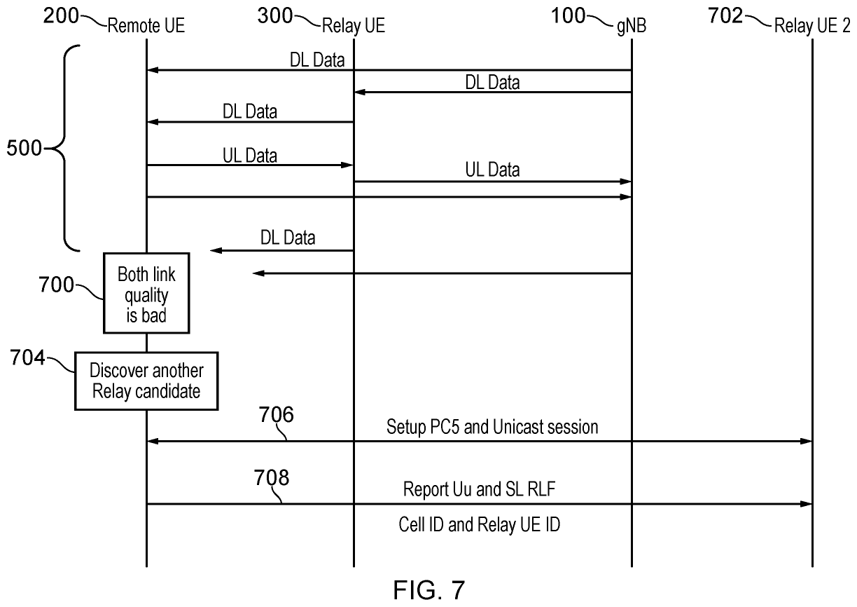

Example embodiments can also provide improvements when both communications links of a multipath communication fail. An example embodiment illustrating a procedure for recovering communications when both a direct and an indirect communication links fail is shown in FIG. 7. As shown in FIG. 7 and in correspondence with the other embodiments of FIGS. 5 and 6, during an initial phase 500, the remote UE 200 receives downlink data in the form of PDUs from the gNB 100, and transmits uplink data as PDUs to the gNB 100 using a multipath communication via a direct communications link (via Uu interface) and via an indirect communications link via the relay UE 300, using a sidelink (PC5) interface). At point 700 however, a link quality of both the PC5 interface with the gNB 100 falls below a predetermined threshold and is considered to be unable to support communication of PDUs or to have failed, and the link quality of communications via the direct communication link on the Uu interface is also considered to be unable to support communication of PDUs or to have failed and so the communication path via the remote UE 300 and directly via the gNB 100 is no longer available. In this example, the remote UE 200 may discover another relay UE 702 in a discovery process 704 before conducting an RRC re-establishment procedure, to re-establish a communications link with either the gNB 100 or another gNB or be instructed to handover to another gNB. Once the remote UE 200 has discovered a new relay UE 702, the remote UE 200 establishes a new sidelink connection 707 with the other remote UE 702. Then the remote UE 200 transmits a report 708 indicating a Uu interface and a sidelink interface radio link failure. A cell ID of the cell which is formed by the gNB 100 for which the Uu interface has experienced a radio link failure and an identifier of the Relay UE 300 (relay UE ID) for identifying the sidelink relay UE 300, which has also suffered a radio link failure are included in information transmitted to the other Relay UE 702. This information can be included in either message 1, message 3 or message 5 which are transmitted to the other remote UE 702 as part of a random access procedure and before security activation or later after PDCP security is activated on the sidelink. That is to say that Uu PDCP security and SL PDCP security will be established. SL security is peer to peer and since this information is going to the gNB, PDCP security make sense.

According to example embodiments therefore, a Cell ID of the cell formed by a gNB which was serving the remote UE 200, which has suffered radio link failure and an identifier of the relay UE, which has also suffered radio link failure for identifying a sidelink the relay UE are included in a message sent by the remote UE to a new relay UE. Having received the cell ID and the identifier of the relay UE which were being used to provide the multipath communication, the wireless communications network can therefore identify the UE context and therefore re-establish the connection faster.

According to other example embodiments a sidelink communications link forming part of multipath communication may use a configured grant resources, for example sidelink configured grant type 1 (SL CG Type 1 resources). When a radio link failure occurs on the direct communications link (Uu interface) and re-establishment is triggered, the configured grant resources of the sidelink may still be valid for sidelink-relays even if the remote UE loses connection to a master cell group (MCG) or cell. As such, there is no need to stop using this type 1 resource when MCG radio link failure occurs and to perform RRC re-establishment, for the sidelink communication, since the remote UE can continue using the sidelink configured grant type 1 resources via sidelink-relays. According to this example embodiment, a configured grant resource of a sidelink relay of an indirect communications link is maintained even though there is a radio link failure on the direct communications link via the Uu interface.

According to other example embodiments, when a remote UE is supported by multipath communication, the remote UE may be configured to prioritise a transmission of uplink data via either the sidelink or an uplink (direct communications link) to the gNB. This is because in some examples, a remote UE cannot perform simultaneous transmission via the uplink Uu interface and the sidelink PC5 interface, for example in the time domain. According to this example embodiment, transmission of data via the uplink or the sidelink is done based on their priorities and thresholds configured by the wireless communications network, that is the radio access network or is pre-configured. When the UE cannot simultaneously perform both V2X sidelink transmission and uplink transmission in the time domain, prioritization between both transmissions is done based on the priorities. According to this example embodiment in a multipath communication, a remote UE informs a gNB of a selected priority between a unicast transmission on a Uu interface and a sidelink on PC5. Accordingly, the remote UE informs the gNB about the selected priority between unicast on UU interface and PC-5 using the selected link so that network can either disable or deactivate multipath configuration.

UE Establishes a Plurality of Direct and/or Indirect Communications Links

In other example embodiments, a UE may establish a multi-path communications link, in which a direct communications path is established using a plurality of carriers, that is a Uu interface with carrier aggregation or dual connectivity, so that if communication on one carrier fails, communications can continue and the RLF can be reported on either a surviving carrier or via a surviving SL.

According to other example embodiments a UE may establish a multipath communication with a radio network infrastructure equipment of the wireless communications network comprising a plurality of direct communications links with the radio network infrastructure equipment and a plurality of indirect communications link via a plurality of relay communications devices each including a SL communications link with the relay device, the plurality relay communications devices providing direct communications link with the radio network infrastructure equipment. The UE may be configured to transmit data units to the radio network infrastructure equipment using the multipath communication, or receiving data units from the radio network infrastructure equipment using the multipath communication. The UE is then configured to determine that a link quality of one or more of the plurality indirect communications links can no longer support the communication of the data units by the transmitting of the data units to the radio network infrastructure equipment or by the receiving of the data units from the radio network infrastructure equipment, or to determine that a link quality of one or more of the plurality of direct communications links can no longer support the communication of the data units by the transmitting of the data units to the radio network infrastructure equipment or by the receiving of the data units from the radio network infrastructure equipment. The UE is also configured to identify at least one surviving one of the plurality of indirect communications links or one of the plurality of direct communications links, and to transmit an indication via the at least one surviving communications link that the one or more of the plurality of direct communications links or the one or more of the plurality of indirect communications links can no longer support the communication of the data units. If the at least one surviving communications link is an indirect communications link, the UE is configured to transmit an indication of a cell identifier of a cell formed by the radio network infrastructure equipment and an identifier of a relay communications device which forms the indirect communications link, which can be used by the wireless communications network for recovering any of the data units which have been lost. If the at least one surviving communications link is a direct communications link transmitting an indication of a cell identifier of a cell formed by the radio network infrastructure equipment which forms the direct communications link, which can be used by the wireless communications network for recovering any of the data units which have been lost.

The following numbered paragraphs provide further example aspects and features of the present technique:

Paragraph 1. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
transmitting data units to the radio network infrastructure equipment using the multipath communication, or receiving data units from the radio network infrastructure equipment using the multipath communication, wherein the method comprises
determining that a link quality of the indirect communications link can no longer support the communication of the data units by the transmitting of the data units to the radio network infrastructure equipment or by the receiving of the data units from the radio network infrastructure equipment via the sidelink communications link, and
transmitting an indication via the direct communications link that the indirect communications link can no longer support the communication of the data units with an indication that the indirect communications path is released and with a status report of the transmission or the reception of the data units for use in recovering any of the data units which have been lost.

Paragraph 2. A method of paragraph 1, wherein if the link quality of the indirect communications link is determined to no longer support the communication of the data units, the status report, transmitted via the direct communications link to the radio network infrastructure equipment, comprises an indication of the data units which have been transmitted via the indirect communications link before the indirect communications link was determined to no longer support the communication of the data units or the data units which have been received from the indirect communications link before the indirect communications link was determined to no longer support the communication of data units.

Paragraph 3. A method of paragraph 1, wherein if the link quality of the indirect communications link is determined to no longer support the communication of the data units, the status report comprises an indication of the data units which have not been transmitted via the indirect communications link as a result of the indirect communications link being determined as no longer able to support the communication of the data units or a last of the data units to have been received from the indirect communications link before the indirect communications link was determined to no longer support the communication of data units.

Paragraph 4. A method of paragraphs 1, 2 or 3, wherein the indication that the indirect communications link can no longer support the communication of the data units with the indication that the indirect communications path is released with the status report of the transmission or the reception of the data units is transmitted to the radio network infrastructure equipment using a Uu message.

Paragraph 5. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and a plurality of indirect communications link via a plurality of relay communications devices including a plurality of sidelink communications links with the plurality of relay communications devices, each of the plurality of the relay communications devices each providing other direct communications links with the radio network infrastructure equipment,
transmitting data units to the radio network infrastructure equipment using the multipath communication, or receiving data units from the radio network infrastructure equipment using the multipath communication, wherein the method comprises
determining that a link quality of at least one of the indirect communications links with at least one of the plurality of relay devices can no longer support the communication of the data units by the transmitting of the data units to the radio network infrastructure equipment or by the receiving of the data units from the radio network infrastructure equipment via at least one of the sidelink communications links respectively, and
transmitting an indication via the direct communications link of the determined one or more of the plurality of indirect communications links which can no longer support the communication of the data units which are released with a status report of the transmission or the reception of the data units for use in recovering any of the data units which have been lost for use in recovering any of the data units which have been lost.

Paragraph 6. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
transmitting data units to the radio network infrastructure equipment using the multipath communication, or receiving data units from the radio network infrastructure equipment using the multipath communication, wherein the method comprises
determining that a link quality of the direct communications link can no longer support the communication of the data units by the transmitting of the data units to the radio network infrastructure equipment or by the receiving of the data units from the radio network infrastructure equipment, and
transmitting an indication via the indirect communications link that the direct communications link can no longer support the communication of the data units.

Paragraph 7. A method of paragraph 6, comprising with a status report of the transmission or the reception of the data units for use in recovering any of the data units which have been lost.

Paragraph 8. A method of paragraph 6, wherein if the link quality of the direct communications link is determined to no longer support the communication of the data units, the status report comprises an indication of the data units which have been transmitted via the direct communications link before the direct communications link was determined to no longer support the communication of the data units or the data units which have been received from the direct communications link before the direct communications link was determined to no longer support the communication of data units.

Paragraph 9. A method of paragraph 6, wherein if the link quality of the direct communications link is determined to no longer support the communication of the data units, the status report comprises an indication of the data units which not have been transmitted via the direct communications link as a result of the direct communications link being determined as no longer able to support the communication of the data units or a last of the data units to have been received from the direct communications link before the direct communications link was determined to no longer support the communication of data units.

Paragraph 10. A method of any of paragraphs 1 to 9, wherein the data units are packet data convergence protocol, PDCP, packet data units, PDUs, the transmission and reception of the PDUs being control by a PDCP layer connection with a PDCP layer in the radio network infrastructure equipment.

Paragraph 11. A method of any of paragraphs 1 to 10, comprising monitoring the link quality of one or both of the indirect communications link and the direct communications link or receiving from the radio network infrastructure equipment an indication of the link quality of one or both of the indirect communications link and the direct communications link, and the determining that the link quality of the indirect communications link can no longer support the communication of the data units comprises determining that the link quality has fallen below a first predetermined threshold, and the determining that the link quality of the direct communications link can no longer support the communication of the data units comprises determining that the link quality has fallen below a second predetermined threshold.

Paragraph 12. A method of paragraph 11, wherein the first predetermined threshold is the same as the second predetermined threshold.

Paragraph 13. A method of paragraph 11, wherein the monitoring the link quality of the indirect communications link includes monitoring a link quality of the sidelink communications link with the relay communications device or receiving from the radio network infrastructure equipment an indication of the link quality of the sidelink communications link with the relay communications device, and the determining that the link quality of the indirect communications link can no longer support the communication of the data units comprises determining that the link quality of the sidelink communications link with the relay communications device has fallen below the second predetermined threshold.

Paragraph 14. A method of paragraph 11, wherein the determining that the link quality of the indirect communications link can no longer support the communication of the data units comprises detecting that the indirect communications link has suffered a radio link failure, and the determining that the link quality of the direct communications link can no longer support the communication of the data units comprises detecting that the direct communications link has suffered a radio link failure.

Paragraph 15. A method of any of paragraphs 1 to 14, wherein the multipath communication comprises transmitting the data units by switching the data units between the direct communications link and the indirect communications link or replicating the data units and transmitting the data units on both of the direct and the indirect communications links or receiving the data units which have been transmitted by the radio network infrastructure equipment switch between the direct communications link and the indirect communications link or replicated and transmitted on both of the direct and the indirect communications links.

Paragraph 16. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and an indirect communications link via a first relay communications devices including a sidelink communications link with the first relay communications device, the first relay communications device providing a second communications link with the radio network infrastructure equipment,
transmitting data units to the radio network infrastructure equipment using the multipath communication, or receiving data units from the radio network infrastructure equipment using the multipath communication,
determining that a link quality of the indirect communications link can no longer support the communication of the data units by the transmitting of the data units to the radio network infrastructure equipment or by the receiving of the data units from the radio network infrastructure equipment, and
determining that a link quality of the direct communications link can no longer support the communication of the data units by the transmitting of the data units to the radio network infrastructure equipment or by the receiving of the data units from the radio network infrastructure equipment,
discovering another communications device, which can act as a relay communications device,
establishing a new sidelink communications link with the discovered relay communications device, the discovered relay communications device providing a third direct communications link with the radio network infrastructure equipment or with another radio network infrastructure equipment,
transmitting an indication via the new sidelink communications link that direct communications link and the indirect communications link can no longer support the communication of the data units, and
transmitting an indication of a cell identifier of a cell formed by the radio network infrastructure equipment and an identifier of the first relay communications device, which can be used by the wireless communications network for recovering any of the data units which have been lost.

Paragraph 17. A method performed by a communications device to transmit data to or to receive data from a wireless communications network, the method comprising
establishing a multipath communication with a radio network infrastructure equipment of the wireless communications network comprising a plurality of direct communications links with the radio network infrastructure equipment and a plurality of indirect communications link via a plurality of relay communications devices each including a sidelink communications link with the communications device, the plurality relay communications devices providing direct communications link with the radio network infrastructure equipment,
transmitting data units to the radio network infrastructure equipment using the multipath communication, or receiving data units from the radio network infrastructure equipment using the multipath communication,
determining that a link quality of one or more of the plurality indirect communications links can no longer support the communication of the data units by the transmitting of the data units to the radio network infrastructure equipment or by the receiving of the data units from the radio network infrastructure equipment, or
determining that a link quality of one or more of the plurality of direct communications links can no longer support the communication of the data units by the transmitting of the data units to the radio network infrastructure equipment or by the receiving of the data units from the radio network infrastructure equipment,
identifying at least one surviving one of the plurality of indirect communications links or one of the plurality of direct communications links, and
transmitting an indication via the at least one surviving communications link of one or more of the plurality of direct communications links or one or more of the plurality of indirect communications links can no longer support the communication of the data units, and
if the at least one surviving communications link is an indirect communications link transmitting an indication of a cell identifier of a cell formed by the radio network infrastructure equipment and an identifier of a relay communications device which forms the indirect communications link, which can be used by the wireless communications network for recovering of the data units which have been lost,
if the at least one surviving communications link is a direct communications link transmitting an indication of a cell identifier of a cell formed by the radio network infrastructure equipment which forms the direct communications link, which can be used by the wireless communications network for recovering any of the data units which have been lost.

Paragraph 18. A method of paragraph 17, comprising transmitting a status report, via the new sidelink communications link, the status report indicating a status of the transmission or the reception of the data units for use in recovering any of the data units which have been lost as a result of the direct and the indirect communications links being no longer able to support the communication of the data units.

Paragraph 19. A method of paragraph 18, wherein if the link quality of the indirect communications link and the direct communications link is determined to no longer support the communication of the data units, the status report comprises an indication of the data units which have been transmitted via the indirect and the direct communications link before being determined to no longer support the communication of the data units or the data units which have been received from the indirect and the direct communications link before being determined to no longer support the communication of data units.

Paragraph 20. A method of paragraph 18, wherein if the link quality of the indirect communications link and the direct communications link is determined to no longer support the communication of the data units, the status report comprises an indication of the data units which have not been transmitted as a result of the indirect and direct communications links being determined as no longer able to support the communication of the data units or a last of the data units to have been received from the indirect and direct communications links before being determined to no longer support the communication of data units.

Paragraph 21. A method of any of paragraphs 18, 19 or 20, wherein the data units are packet data convergence protocol, PDCP, packet data units, PDUs, the transmission and reception of the PDUs being control by a PDCP layer connection with a PDCP layer in the radio network infrastructure equipment.

Paragraph 22. A method of any of paragraphs 17 to 21, comprising monitoring the link quality of the indirect communications link and the direct communications link or receiving from the radio network infrastructure equipment an indication of the link quality of the indirect communications link and the direct communications link, and the determining that the link quality of the indirect communications link can no longer support the communication of the data units comprises determining that the link quality has fallen below a first predetermined threshold, and the determining that the link quality of the direct communications link can no longer support the communication of the data units comprises determining that the link quality has fallen below a second predetermined threshold.

Paragraph 23. A method of paragraph 22, wherein the first predetermined threshold is the same and the second predetermined threshold.

Paragraph 24. A method of any of paragraphs 16 to 23, wherein the multipath communication comprises transmitting the data units by splitting the data units between the direct communications link and the indirect communications link or replicating the data units and transmitting the data units on both of the direct and the indirect communications links or receiving the data units which have been transmitted by the radio network infrastructure equipment switched between the direct communications link and the indirect communications link or replicated and transmitted on both of the direct and the indirect communications links.

Paragraph 25. A method performed by a communications device to transmit data to or to receive data from a wireless communications network, the method comprising
establishing a multipath communication with a radio network infrastructure equipment of the wireless communications network comprising a plurality of direct communications links with the radio network infrastructure equipment and a plurality of indirect communications link via a plurality of relay communications devices each including a sidelink communications link with the communications device, the plurality relay communications devices providing direct communications link with the radio network infrastructure equipment,
transmitting data units to the radio network infrastructure equipment using the multipath communication, or receiving data units from the radio network infrastructure equipment using the multipath communication,
determining that a link quality of one or more of the plurality indirect communications links can no longer support the communication of the data units by the transmitting of the data units to the radio network infrastructure equipment or by the receiving of the data units from the radio network infrastructure equipment, or
determining that a link quality of one or more of the plurality of direct communications links can no longer support the communication of the data units by the transmitting of the data units to the radio network infrastructure equipment or by the receiving of the data units from the radio network infrastructure equipment,
identifying at least one surviving one of the plurality of indirect communications links or one of the plurality of direct communications links, and
transmitting an indication via the at least one surviving communications link of one or more of the plurality of direct communications links or one or more of the plurality of indirect communications links can no longer support the communication of the data units, and
if the at least one surviving communications link is an indirect communications link transmitting an indication of a cell identifier of a cell formed by the radio network infrastructure equipment and an identifier of a relay communications device which forms the indirect communications link, which can be used by the wireless communications network for recovering any of the data units which have been lost, or
if the at least one surviving communications link is a direct communications link transmitting an indication of a cell identifier of a cell formed by the radio network infrastructure equipment which forms the direct communications link, which can be used by the wireless communications network for recovering any of the data units which have been lost.

Paragraph 26. A method of paragraph 25, comprising transmitting a status report, via the surviving communications link, the status report indicating a status of the transmission or the reception of the data units for use in recovering any of the data units which have been lost as a result of the direct and the indirect communications links being no longer able to support the communication of the data units.

Paragraph 27. A method of any of paragraphs 25 or 26, wherein the data units are packet data convergence protocol, PDCP, packet data units, PDUs, the transmission and reception of the PDUs being control by a PDCP layer connection with a PDCP layer in the radio network infrastructure equipment.

Paragraph 28. A method of any of paragraphs 25 to 27, comprising monitoring the link quality of the indirect communications link and the direct communications link or receiving from the radio network infrastructure equipment an indication of the link quality of the indirect communications link and the direct communications link, and the determining that the link quality of one or more of the plurality indirect communications links can no longer support the communication of the data units comprises determining that the link quality has fallen below a first predetermined threshold, and the determining that the link quality of one or more of the plurality direct communications links can no longer support the communication of the data units comprises determining that the link quality has fallen below a second predetermined threshold.

Paragraph 29. A method of paragraph 28, wherein the first predetermined threshold is the same and the second predetermined threshold.

Paragraph 30. A method of any of paragraphs 25 to 29, wherein the multipath communication comprises transmitting the data units by splitting the data units between the plurality of direct communications links and the plurality of indirect communications link or replicating the data units and transmitting the data units on the plurality of direct communications links and the plurality of indirect communications links or receiving the data units which have been transmitted by the radio network infrastructure equipment switched between the plurality of direct communications link and the plurality of indirect communications links or replicated and transmitted on both of the direct and the indirect communications links.

Paragraph 31. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
transmitting data units to the radio network infrastructure equipment using the multipath communication, or receiving data units from the radio network infrastructure equipment using the multipath communication, wherein the sidelink communications link with the relay communications device is formed from configured grant resources of a sidelink wireless interface, and the method comprises
determining that a link quality of the direct communications link can no longer support the communication of the data units by the transmitting of the data units to the radio network infrastructure equipment or by the receiving of the data units from the radio network infrastructure equipment,
performing a re-establishment procedure to re-establish the direct communication link with the radio network infrastructure equipment,
transmitting the data units to the radio network infrastructure equipment using the re-established direct communications link or receiving data units from the radio network infrastructure equipment using the re-established direct communications link and transmitting the data units to the radio network infrastructure equipment using the configured grant resources already established for the sidelink communications link or receiving data units from the radio network infrastructure equipment using the configured grant resources already established for the sidelink communications link according to the multipath communication.

Paragraph 32. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
transmitting data units to or receiving data units from the radio network infrastructure equipment using the multipath communication, wherein the transmitting data units to the radio network infrastructure equipment using the multipath communication comprises
determining that the data units for the uplink cannot be simultaneously transmitted to the radio network infrastructure equipment using the indirect communications link and the direct communications link,
prioritising a transmission of uplink data units by selecting either the indirect communications link via the sidelink communications link or the direct communications link, and
transmitting the data units to the radio network infrastructure equipment using either the selected sidelink communications link or the selected direct communications link.

Paragraph 33. A method of paragraph 32, comprising
transmitting an indication to the radio network infrastructure equipment of the selected one of the indirect communications link via the sidelink communications link or the direct communications link, the multipath communication being disabled for the uplink.

Paragraph 34. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device,
controller circuitry configured to control the transceiver circuitry to establish a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment, and to transmit data units to the radio network infrastructure equipment using the multipath communication, or to receive data units from the radio network infrastructure equipment using the multipath communication, wherein the controller circuitry is configured
to determine that a link quality of the indirect communications link can no longer support the communication of the data units by the transmitting of the data units to the radio network infrastructure equipment or by the receiving of the data units from the radio network infrastructure equipment via the sidelink communications link, and
to control the transmitter circuitry to transmit an indication via the direct communications link that the indirect communications link can no longer support the communication of the data units with an indication that the indirect communications path is released and with a status report of the transmission or the reception of the data units for use in recovering any of the data units which have been lost.

Paragraph 35. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device,
controller circuitry configured to control the transceiver circuitry to establish a multipath communication with a radio network infrastructure equipment of the wireless communications network comprising a first direct communications link with the radio network infrastructure equipment and a plurality of indirect communications link via a plurality of relay communications devices including a plurality of sidelink communications links with the plurality of relay communications devices, each of the plurality of the relay communications devices each providing other direct communications links with the radio network infrastructure equipment, and to transmit data units to the radio network infrastructure equipment using the multipath communication, or to receive data units from the radio network infrastructure equipment using the multipath communication, wherein the controller circuitry is configured
to determine that a link quality of at least one of the indirect communications links with at least one of the plurality of relay devices can no longer support the communication of the data units by the transmitting of the data units to the radio network infrastructure equipment or by the receiving of the data units from the radio network infrastructure equipment via at least one of the sidelink communications links respectively, and
to transmit an indication via the direct communications link of the determined one or more of the plurality of indirect communications links which can no longer support the communication of the data units which are released with a status report of the transmission or the reception of the data units for use in recovering any of the data units which have been lost for use in recovering any of the data units which have been lost.

Paragraph 36. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device, controller circuitry configured to control the transceiver circuitry
to establish a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
transmitting data units to the radio network infrastructure equipment using the multipath communication, or receiving data units from the radio network infrastructure equipment using the multipath communication, wherein the controller circuitry is configured
to determine that a link quality of the direct communications link can no longer support the communication of the data units by the transmitting of the data units to the radio network infrastructure equipment or by the receiving of the data units from the radio network infrastructure equipment, and
to control the transceiver circuitry to transmit an indication via the indirect communications link that the direct communications link can no longer support the communication of the data units with a status report of the transmission or the reception of the data units for use in recovering any of the data units which have been lost.

Paragraph 37. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device, controller circuitry configured to control the transceiver circuitry
to establish a multipath communication with a radio network infrastructure equipment of the wireless communications network comprising a first direct communications link with the radio network infrastructure equipment and an indirect communications link via a first relay communications devices including a sidelink communications link with the first relay communications device, the first relay communications device providing a second direct communications link with the radio network infrastructure equipment,
to transmit data units to the radio network infrastructure equipment using the multipath communication, or receiving data units from the radio network infrastructure equipment using the multipath communication, wherein the controller circuitry is configured
to determine that a link quality of the indirect communications link can no longer support the communication of the data units by the transmitting of the data units to the radio network infrastructure equipment or by the receiving of the data units from the radio network infrastructure equipment, and
to determine that a link quality of the direct communications link can no longer support the communication of the data units by the transmitting of the data units to the radio network infrastructure equipment or by the receiving of the data units from the radio network infrastructure equipment,
to discover another communications device, which can act as a relay communications device,
to establish a new sidelink communications link with the discovered relay communications device, the discovered relay communications device providing a third direct communications link with the radio network infrastructure equipment or with another radio network infrastructure equipment,
to control the transceiver circuitry to transmit an indication via the new sidelink communications link that direct communications link and the indirect communications link can no longer support the communication of the data units, and
to control the transceiver circuitry to transmit an indication of a cell identifier of a cell formed by the radio network infrastructure equipment and an identifier of the first relay communications device, which can be used by the wireless communications network for recovering any of the data units which have been lost.

Paragraph 38. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device, and controller circuitry configured to control the transceiver circuitry
to establish a multipath communication with a radio network infrastructure equipment of the wireless communications network comprising a plurality of direct communications links with the radio network infrastructure equipment and a plurality of indirect communications link via a plurality of relay communications devices each including a sidelink communications link with the communications device, the plurality relay communications devices providing direct communications link with the radio network infrastructure equipment,
to transmit data units to the radio network infrastructure equipment using the multipath communication, or receiving data units from the radio network infrastructure equipment using the multipath communication, wherein the controller circuitry is configured
to determine that a link quality of one or more of the plurality indirect communications links can no longer support the communication of the data units by the transmitting of the data units to the radio network infrastructure equipment or by the receiving of the data units from the radio network infrastructure equipment, or
to determine that a link quality of one or more of the plurality of direct communications links can no longer support the communication of the data units by the transmitting of the data units to the radio network infrastructure equipment or by the receiving of the data units from the radio network infrastructure equipment,
to identify at least one surviving one of the plurality of indirect communications links or one of the plurality of direct communications links, and
to control the transceiver circuitry to transmit an indication via the at least one surviving communications link of one or more of the plurality of direct communications links or one or more of the plurality of indirect communications links can no longer support the communication of the data units, and
if the at least one surviving communications link is an indirect communications link to control the transceiver circuitry to transmit an indication of a cell identifier of a cell formed by the radio network infrastructure equipment and an identifier of a relay communications device which forms the indirect communications link, which can be used by the wireless communications network for recovering any of the data units which have been lost, or
if the at least one surviving communications link is a direct communications link to control the transceiver circuitry to transmit an indication of a cell identifier of a cell formed by the radio network infrastructure equipment which forms the direct communications link, which can be used by the wireless communications network for recovering any of the data units which have been lost.

Paragraph 39. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device,
   controller circuitry configured to control the transceiver circuitry
to establish a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment, and
to transmit data units to the radio network infrastructure equipment using the multipath communication, or receiving data units from the radio network infrastructure equipment using the multipath communication, wherein the sidelink communications link with the relay communications device is formed from configured grant resources of a sidelink wireless interface, and the controller circuitry is configured the transceiver circuitry
to determine that a link quality of the direct communications link can no longer support the communication of the data units by the transmitting of the data units to the radio network infrastructure equipment or by the receiving of the data units from the radio network infrastructure equipment,
to perform a re-establishment procedure to re-establish the direct communication link with the radio network infrastructure equipment,
to control the transceiver circuitry to transmit the data units to the radio network infrastructure equipment using the re-established direct communications link or receiving data units from the radio network infrastructure equipment using the re-established direct communications link and transmitting the data units to the radio network infrastructure equipment using the configured grant resources already established for the sidelink communications link or receiving data units from the radio network infrastructure equipment using the configured grant resources already established for the sidelink communications link according to the multipath communication.

Paragraph 40. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device, and controller circuitry configured to control the transceiver circuitry
to establish a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
to control the transceiver unit to transmit data units to or to receive data units from the radio network infrastructure equipment using the multipath communication, wherein the controller circuitry is configured to control the transceiver circuitry to transmit data units to the radio network infrastructure equipment using the multipath communication by
determining that the data units for the uplink cannot be simultaneously transmitted to the radio network infrastructure equipment using the indirect communications link and the direct communications link,
prioritising a transmission of uplink data units by selecting either the indirect communications link via the sidelink communications link or the direct communications link, and
transmitting the data units to the radio network infrastructure equipment using either the selected sidelink communications link or the selected direct communications link.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

TS 38.470
TS 38.423
TS 38.300
TS 38.323
TS 38.331

1. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
transmitting data units to the radio network infrastructure equipment using the multipath communication, or receiving data units from the radio network infrastructure equipment using the multipath communication, wherein the method comprises
determining that a link quality of the indirect communications link can no longer support the communication of the data units by the transmitting of the data units to the radio network infrastructure equipment or by the receiving of the data units from the radio network infrastructure equipment via the sidelink communications link, and
transmitting an indication via the direct communications link that the indirect communications link can no longer support the communication of the data units with an indication that the indirect communications path is released and with a status report of the transmission or the reception of the data units for use in recovering any of the data units which have been lost.

2. A method of claim 1, wherein if the link quality of the indirect communications link is determined to no longer support the communication of the data units, the status report, transmitted via the direct communications link to the radio network infrastructure equipment, comprises an indication of the data units which have been transmitted via the indirect communications link before the indirect communications link was determined to no longer support the communication of the data units or the data units which have been received from the indirect communications link before the indirect communications link was determined to no longer support the communication of data units.

3. A method of claim 1, wherein if the link quality of the indirect communications link is determined to no longer support the communication of the data units, the status report comprises an indication of the data units which have not been transmitted via the indirect communications link as a result of the indirect communications link being determined as no longer able to support the communication of the data units or a last of the data units to have been received from the indirect communications link before the indirect communications link was determined to no longer support the communication of data units.

4. A method of claims 1, wherein the indication that the indirect communications link can no longer support the communication of the data units with the indication that the indirect communications path is released with the status report of the transmission or the reception of the data units is transmitted to the radio network infrastructure equipment using a Uu message.

5. A method performed by a communications device to transmit data to or to receive data from a wireless communications network, the method comprising
establishing a multipath communication with a radio network infrastructure equipment of the wireless communications network comprising a first direct communications link with the radio network infrastructure equipment and a plurality of indirect communications link via a plurality of relay communications devices including a plurality of sidelink communications links with the plurality of relay communications devices, each of the plurality of the relay communications devices each providing other direct communications links with the radio network infrastructure equipment,
transmitting data units to the radio network infrastructure equipment using the multipath communication, or receiving data units from the radio network infrastructure equipment using the multipath communication, wherein the method comprises
determining that a link quality of at least one of the indirect communications links with at least one of the plurality of relay devices can no longer support the communication of the data units by the transmitting of the data units to the radio network infrastructure equipment or by the receiving of the data units from the radio network infrastructure equipment via at least one of the sidelink communications links respectively, and transmitting an indication via the direct communications link of the determined one or more of the plurality of indirect communications links which can no longer support the communication of the data units which are released with a status report of the transmission or the reception of the data units for use in recovering any of the data units which have been lost for use in recovering any of the data units which have been lost.

6-9. (canceled)

10. A method of claim 1, wherein the data units are packet data convergence protocol, PDCP, packet data units, PDUs, the transmission and reception of the PDUs being control by a PDCP layer connection with a PDCP layer in the radio network infrastructure equipment.

11. A method of claim 1, comprising monitoring the link quality of one or both of the indirect communications link and the direct communications link or receiving from the radio network infrastructure equipment an indication of the link quality of one or both of the indirect communications link and the direct communications link, and the determining that the link quality of the indirect communications link can no longer support the communication of the data units comprises determining that the link quality has fallen below a first predetermined threshold, and the determining that the link quality of the direct communications link can no longer support the communication of the data units comprises determining that the link quality has fallen below a second predetermined threshold.

12. A method of claim 11, wherein the first predetermined threshold is the same as the second predetermined threshold.

13. A method of claim 11, wherein the monitoring the link quality of the indirect communications link includes monitoring a link quality of the sidelink communications link with the relay communications device or receiving from the radio network infrastructure equipment an indication of the link quality of the sidelink communications link with the relay communications device, and the determining that the link quality of the indirect communications link can no longer support the communication of the data units comprises determining that the link quality of the sidelink communications link with the relay communications device has fallen below the second predetermined threshold.

14. A method of claim 11, wherein the determining that the link quality of the indirect communications link can no longer support the communication of the data units comprises detecting that the indirect communications link has suffered a radio link failure, and the determining that the link quality of the direct communications link can no longer support the communication of the data units comprises detecting that the direct communications link has suffered a radio link failure.

15. A method of claim 1, wherein the multipath communication comprises transmitting the data units by switching the data units between the direct communications link and the indirect communications link or replicating the data units and transmitting the data units on both of the direct and the indirect communications links or receiving the data units which have been transmitted by the radio network infrastructure equipment switch between the direct communications link and the indirect communications link or replicated and transmitted on both of the direct and the indirect communications links.

16-34. (canceled)

35. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device,
controller circuitry configured to control the transceiver circuitry to establish a multipath communication with a radio network infrastructure equipment of the wireless communications network comprising a first direct communications link with the radio network infrastructure equipment and a plurality of indirect communications link via a plurality of relay communications devices including a plurality of sidelink communications links with the plurality of relay communications devices, each of the plurality of the relay communications devices each providing other direct communications links with the radio network infrastructure equipment, and to transmit data units to the radio network infrastructure equipment using the multipath communication, or to receive data units from the radio network infrastructure equipment using the multipath communication, wherein the controller circuitry is configured
to determine that a link quality of at least one of the indirect communications links with at least one of the plurality of relay devices can no longer support the communication of the data units by the transmitting of the data units to the radio network infrastructure equipment or by the receiving of the data units from the radio network infrastructure equipment via at least one of the sidelink communications links respectively, and
to transmit an indication via the direct communications link of the determined one or more of the plurality of indirect communications links which can no longer support the communication of the data units which are released with a status report of the transmission or the reception of the data units for use in recovering any of the data units which have been lost for use in recovering any of the data units which have been lost.

36-39. (canceled)

40. A communication device for transmit data to or to receive data from a wireless communications network, the communications device comprising
transceiver circuitry configured to transmit signals to and to receive signals from one or more radio network infrastructure equipment of the wireless communications network or another communications device acting as a relay communications device, and controller circuitry configured to control the transceiver circuitry
to establish a multipath communication with a radio network infrastructure equipment of the wireless communications network comprising a first direct communications link with the radio network infrastructure equipment and an indirect communications link via a relay communications devices including a sidelink communications link with the relay communications device, the relay communications device providing a second direct communications link with the radio network infrastructure equipment,
to control the transceiver unit to transmit data units to or to receive data units from the radio network infrastructure equipment using the multipath communication, wherein the controller circuitry is configured to control the transceiver circuitry to transmit data units to the radio network infrastructure equipment using the multipath communication by
determining that the data units for the uplink cannot be simultaneously transmitted to the radio network infrastructure equipment using the indirect communications link and the direct communications link,
prioritising a transmission of uplink data units by selecting either the indirect communications link via the sidelink communications link or the direct communications link, and
transmitting the data units to the radio network infrastructure equipment using either the selected sidelink communications link or the selected direct communications link.
